(19) United States
(12) Patent Application Publication
(10) Pub. No.: US 2015/0356889 A1
(43) Pub. Date: Dec. 10, 2015

(54) WEARABLE VIBRATION DEVICE

(71) Applicant: David Todd Schwartz, Livingston, NJ (US)

(72) Inventor: David Todd Schwartz, Livingston, NJ (US)

(21) Appl. No.: 14/298,476

(22) Filed: Jun. 6, 2014

(51) Int. Cl. G09B 21/00; H04R 3/00; G08B 6/00

(52) U.S. Cl. CPC G09B 21/009; G08B 6/00; H04R 3/00; H04R 2460/13

(57) ABSTRACT

A wearable vibration device is provided. The wearable vibration device includes a band having at least one vibration device attached to the band. A power source is operatively connected to the vibration device. The vibration device may further include an input configured to connect to a music playing device. The vibration device produces a vibration based on the output of the music playing device.

### BACKGROUND OF THE INVENTION

The present invention relates to portable music and, more particularly, to a wearable vibration device for use with portable music players.

Currently, many people wear headphones or ear buds to listen to music while using a portable music playing device. However, when listening to music using headphones or ear buds, the user does not experience the feel of the sound similar to music being played at a night club, a concert, or when being played by a loud stereo. Further, the hearing impaired do not experience anything while using headphones or ear buds.

As can be seen, there is a need for a device that adds vibration while listening to music from a portable device.

### SUMMARY OF THE INVENTION

In one aspect of the present invention, a wearable vibration device comprising: a band; at least one vibration device attached to the band; a power source operatively connected to the vibration device; and an input operatively connected to the vibration device, wherein the input is configured to connect to a music playing device, wherein the vibration device is configured to produce a vibration based on the output of the music playing device.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is an exploded view of an embodiment of the present invention; and

FIG. 4 is a top view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a wearable music belt, anklet or bracelet that emits sound waves to allow a user to feel the beat. The present invention may emit sound waves so that a user can feel the beat in their core or in their feet as if the user was hearing the music in a concert, club or through a loud stereo. The present invention facilitates the ability for users to listen to music using a portable device with the sound disseminated into other parts of the body.

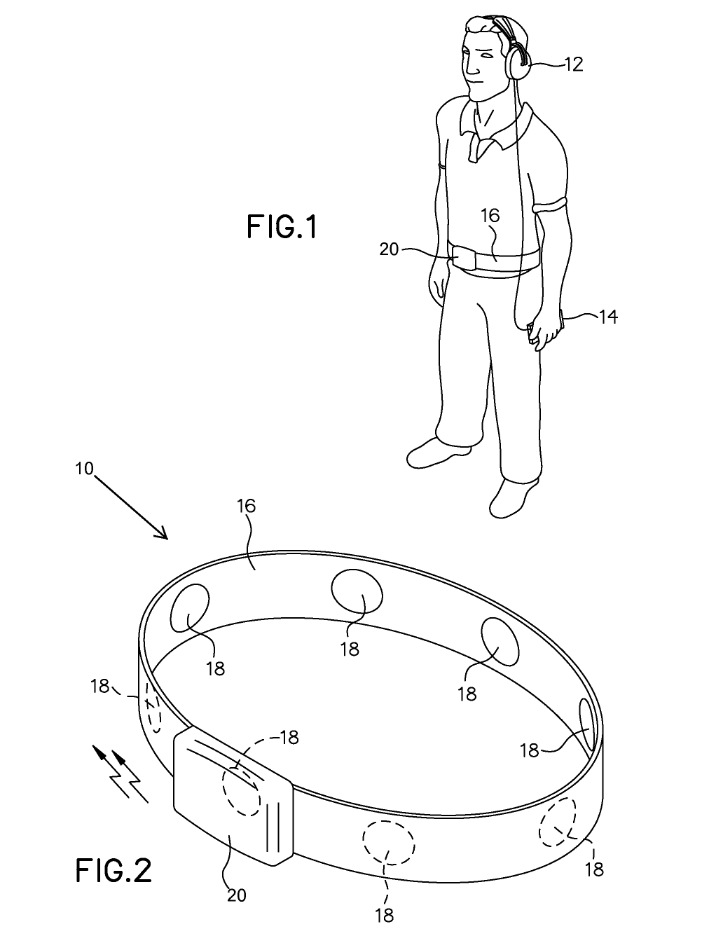

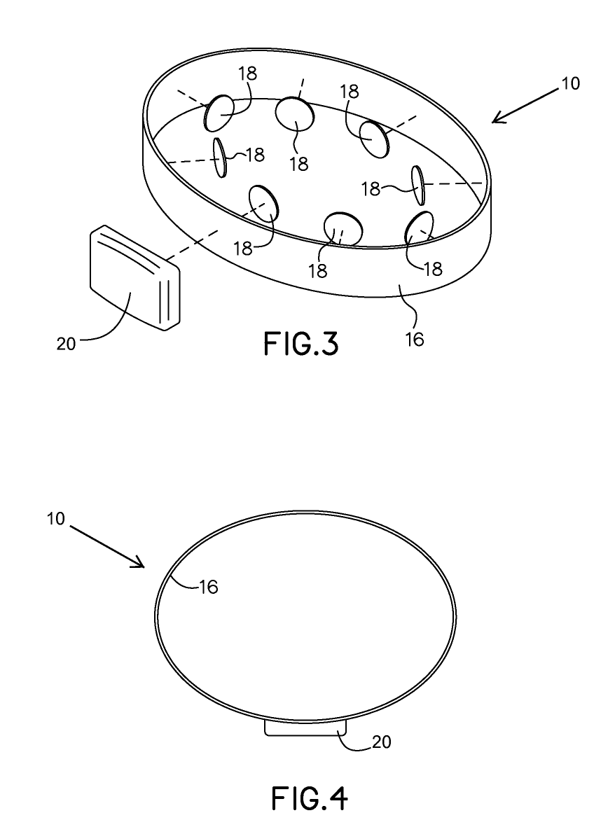

Referring to FIGS. 1 through 4, the present invention includes a wearable vibration device 10. The wearable vibration device 10 includes a band 16 having at least one vibration device 18 attached to the band 16. A power source 20 is operatively connected to the vibration device 18. The vibration device 18 may further include an input configured to connect to a sound producing device 14, such as a music playing device and/or a video game playing device. The vibration device 18 produces a vibration based on the output of the sound producing device 14.

The band 16 may include an inner surface and an outer surface, and may be looped and worn around a user's body with the inside surface facing the user. For example, the band 16 of the present invention may be a belt worn around the user's waist. The band 16 may also be an anklet or bracelet worn on the user's wrist or ankle. In certain embodiments, the band 16 may include a buckle to attach to the user. The band 16 may also be made of a polymer stretchable material and may not need a buckle. In certain embodiments, lights may be attached to the belt that flicker to the music beat.

In certain embodiments, the at least one vibration device 18 may include a plurality of vibration devices 18, such as four to eight vibration devices 18. The vibration device 18 may be attached to band 16 so that the vibration device 18 emits vibrations towards the inner surface. In certain embodiments, the vibration device 18 may be attached to the inner surface of the band 16. The vibration device 18 may be configured to emit a low frequency sound. In certain embodiments, the vibration device 18 may include a subwoofer, a vibration pad, a tactile transducer or a combination thereof. In certain embodiments, there may be a vibration control to control how much vibration or sound is produced by the vibration devices 18. Further, there may be an overdrive feature and a vibration echo with small internal spinning motor.

The vibration device 18 of the present invention may be operatively attachable to the sound producing device 14 with wires or wirelessly. For example, the vibration device 18 may include a wireless input that is connected to a wireless output of the sound producing device 14. In such embodiments, the vibration device 18 may be connected to the sound producing device 14 via Bluetooth®. Therefore the vibration device 18 may output vibrations directly correlating with the bass of the music that is playing on the sound producing device 14 and listened by the user using headphones 12.

The power source 20 of the device may be any suitable power source that is able to power the vibration device 18. For example, a wire plug may be operatively connected to the vibration device 18 which may be connected to AC outlet. In certain embodiments, the power source 20 may include a rechargeable battery that may be removably attachable to the band 16. In such embodiments, the user may recharge their battery and then connect the battery to the band to use the present invention as a portable device.

A method of using the present invention may include the following. A user may place a band 16 including a plurality of vibration devices 18 on their body. For example, the user may wrap the band 16 around their waist. The user may then wirelessly connect the vibration devices 18 to a sound producing device 14, such as an Mp3 player. The user may then select the music to listen to. The vibration devices 18 may then produce vibrations, sound waves or a combination thereof based on the music playing through the headphones 12.

A method of making the present invention may include the following. Custom sheets of flexible plastic may be insulated by foam to form the band 16. The vibration devices 18 may be embedded within the belt. The present invention may further include embedded electric wiring, a rechargeable battery, and wireless or Bluetooth® signal processing. The above mentioned components may be encased in the wearable vibration device 10 which fastens and adjusts to size of the user's waist or ankle.

It should be understood, of course, that the foregoing relates to exemplary embodiments of the invention and that modifications may be made without departing from the spirit and scope of the invention as set forth in the following claims.

What is claimed is:

1. A wearable vibration device comprising:
a band;
at least one vibration device attached to the band;
a power source operatively connected to the vibration device; and
an input operatively connected to the vibration device, wherein the input is configured to connect to a sound producing device,
wherein the vibration device is configured to produce a vibration based on the output of the sound producing device.

2. The wearable vibration device claim 1, wherein the band is a belt formed to fit around a user's waist.

3. The wearable vibration device of claim 1, wherein the band is at least one of a bracelet and an anklet.

4. The wearable vibration device of claim 1, wherein the at least one vibration device is configured to emit a low frequency sound.

5. The wearable vibration device of claim 1, wherein the at least one vibration device is at least one of a subwoofer, a vibration pad, and a tactile transducer.

6. The wearable vibration device of claim 1, wherein the at least one vibration device is a tactile transducer.

7. The wearable vibration device of claim 1, wherein the input is a wireless input wirelessly connectable to a wireless output of the sound producing device.

8. The wearable vibration device of claim 1, wherein the band comprises an inner surface and an outer surface, wherein the at least one vibration device is directed to deliver the vibrations towards the inner surface.

9. The wearable vibration device of claim 8, wherein the at least one vibration device is attached to the inner surface of the band.

10. The wearable vibration device of claim 1, wherein the band is made of a stretchable material.

11. The wearable vibration device of claim 1, wherein the at least one vibration device is a plurality of vibration devices.

12. The wearable vibration device of claim 1, wherein the power source is a rechargeable battery.

13. The wearable vibration device of claim 1, wherein the sound producing device is a music playing device.

14. The wearable vibration device of claim 1, wherein the sound producing device is a video game playing device.
